(19) United States
(12) Patent Application Publication
(10) Pub. No.: US 2022/0251321 A1
(43) Pub. Date: Aug. 11, 2022

(54) EXPANDED BEADS HAVING DENSITY AND/OR CELL MORPHOLOGY GRADIENTS, AND SINTERED FOAMS OBTAINED THEREFROM

(71) Applicant: MATERIAS S.r.l., Napoli (IT)

(72) Inventors: Ernesto DI MAIO, Napoli (IT); Fabrizio ERRICHIELLO, Napoli (IT); Aniello CAMMARANO, Napoli (IT); Luigi NICOLAIS, Ercolano (NA) (IT)

(73) Assignee: MATERIAS S.r.l., Napoli (IT)

(21) Appl. No.: 17/629,263

(22) PCT Filed: Jul. 22, 2020
(86) PCT No.: PCT/IB2020/056883

§ 371 Date: Jan. 21, 2022

(30) Foreign Application Priority Data
Jul. 23, 2019 (IT) 102019000012666

(51) Int. Cl. C08J 9/232; C08J 9/18; C08J 9/14; C08J 9/12

(52) U.S. Cl. CPC C08J 9/232; C08J 9/18; C08J 9/146; C08J 2203/142; C08J 9/122; C08J 2207/10; C08J 2203/06; C08J 9/141

(57) ABSTRACT

The present invention relates to a foamed sintered polymeric material with improved mechanical properties and a process for the preparation thereof comprising the following steps: providing an expandable polymeric material in the form of granules, solubilizing with a time-varying pressure profile said one or more blowing agents in the expandable polymeric material, expanding said granules to form said expanded beads by instantly releasing the pressure or by pressure release and subsequent heating, and sintering together said expanded beads, preferably at a temperature higher than 30° C.

### FIELD OF INVENTION

The present invention relates to a method to make sintered foamed polymeric materials obtained from expanded beads having density and/or cell morphology gradients.

In particular, the method uses a step of solubilization of one or more physical blowing agents in granules of expandable polymeric material characterized by time-varying conditions followed by a step of expansion of said granules and sintering of the expanded beads thus obtained. The time-varying conditions of the solubilization step generate in the granules non-uniform profiles of the concentrations of the physical blowing agents, which, at the time of expansion, generate correspondingly non-uniform density and/or morphology in the expanded beads, and which, at the time of sintering, generate foamed sintered artifacts with improved structural and functional properties with respect to the same foamed and sintered artifacts obtained from expanded beads with uniform cell density and morphology and equivalent average density.

### STATE OF THE ART

Recently an interest has developed towards “gradiently” foamed materials, whose structural and functional properties are improved compared to foamed materials characterized by uniform structures in terms of density and cell morphologies.

This has been demonstrated through recent scientific studies, both theoretical-numerical and experimental, such as Liang Cui et al., “Designing the energy absorption capacity of functionally graded foam materials”, Materials Science and Engineering: A. 507 (1-2):215-225, May 2009. The patent and scientific literature describes the use and advantage of such layered foam structures or with a gradient of morphology and/or density.

Patent application publication no. US2015125663, describes the use of different layers of polymer foams, “gradiently” assembled, in the absorption of impact energy in helmets.

Another field in which stratified foams are of interest is that of expansion by sintering, very common in the production of sintered foamed polystyrene artifacts (a technology of “steam chest molding” or “bead foaming”), but more recently also using, among others, polypropylene, thermoplastic polyurethane and polylactic acid.

In this field, pre-expanded beads (with a substantial cylindrical, ellipsoidal, or spherical shape and dimensions of the order of a few millimeters) are used, which, in the production of the artifact, are inserted into a mold and invested by water vapor or hot gases to carry out the final expansion and sintering of the beads. The final expansion is by blowing agents, such as, for example, pentane, still contained in solution in the pre-expanded bead, which evolve with heating, but also by the thermal expansion of the gas contained in the bubbles, following heating.

US2015252163 describes a hybrid material that comprises a polyurethane matrix containing thermoplastic polyurethane foam particles, a manufacturing process for such hybrid materials and the use of such hybrid materials such as bicycle saddles, upholstery and shoe soles.

U.S. Pat. No. 9,079,360 describes a process to produce a printed article using pre-expanded polyolefin beads comprising a cylindrical foamed center layer and a non-expanded outer layer covering it, where the pre-expanded beads are obtained by a co-extrusion process.

Patent application IT 102018000004727 filed on 19 Apr. 2018 on behalf of the same Applicant describes a process for obtaining stratified polymeric foamed materials, comprising at least two layers of different density and/or morphology.

### SUMMARY OF THE INVENTION

Following further studies, the Applicant has surprisingly observed that the finished artifacts made by sintering multi-layer beads obtained through the method described in the patent application IT 102018000004727 had particular and characteristic mechanical properties different from those achievable starting from beads with uniform morphology and density.

The mechanical properties of a uniform foam are dictated, fixing the starting polymer, in a very large part by the density of the foam and in a minority, often negligible, by the morphology, in terms of number and size of the bubbles. This is true both for foams produced by sintering (for example, so-called EPS, expandable polystyrene) and for monolithic foams, produced for example by extrusion (so-called XPS).

Taking into account, for example, the compression elastic modulus (or stiffness) of a uniform foam, according to established literature [L. J. Gibson, M. F. Ashby. Cellular solids. Structure & properties. Pergamon Press, Oxford 1988] this varies with the square of the density ratio between foam and dense polymer. The other characteristics of a foam, such as size distribution and average pore size, have less effect. Then, for the same density it is rather difficult to obtain variations in stiffness. Similar considerations apply to many other properties, such as yield strength, fatigue strength, shear modulus, flexural strength, plateau stress, thermal conductivity, and so on.

On the other hand, the Applicant has surprisingly observed that the stiffness of finished products made from multi-layer beads varied according to the gradient of morphology and density of the beads used, for the same average foam density.

In particular, the Applicant observed that for the same average density, greater stiffness was achieved when the beads had an outer layer denser than the inner layer, and less stiffness when the beads had an outer layer less dense than the inner layer.

Therefore, a first object of the present invention is a process to prepare a foamed polymeric material comprising sintered expanded beads by the use of one or more blowing agents, characterized in that this process comprises the following steps:
providing an expandable polymeric material in the form of granules,
solubilizing with a time-varying pressure profile said one or more blowing agents in the expandable polymeric material,
expanding said granules to form said expanded beads by instantly releasing the pressure or by pressure release and subsequent heating, and
sintering together said expanded beads, preferably at a temperature higher than 30° C.

A second object of the present invention is represented by a foamed polymeric material comprising sintered expanded beads obtained with the process according to the first object of the present invention, where said foamed polymeric material, for the same average density, shows mechanical and functional properties dependent on said time-varying pressure profile.

A third object of the present invention is represented by a foamed polymeric material comprising sintered expanded beads characterized by welding layers between said sintered expanded beads with density greater or lower than the average density of said foamed polymeric material.

A fourth object of the present invention is represented by a manufactured article made in whole or in part from polymeric material according to the second or third object of the present invention.

### BRIEF DESCRIPTION OF THE FIGURES

FIG. 1A shows a photograph of the discontinuous foaming apparatus used in the present invention.

FIG. 1B shows a diagram of the discontinuous foaming apparatus used in the present invention.

FIG. 1C shows a diagram of the cylindrical mold in which the granules are housed.

FIG. 2 shows the products obtained from the sintering of expanded beads with gradient morphology and, below each sintered product, the corresponding beads: a) example 1; b) example 2; c) example 3; d) example 4.

FIG. 3A shows the SEM image of a section of the TPU sample obtained with the conditions shown in Example 1.

FIG. 3B shows a magnification of FIG. 3A showing the interconnecting/welding areas between the expanded beads.

FIG. 4A shows the SEM image of a section of the TPU sample obtained under the conditions shown in Example 2.

FIG. 4B shows a magnification of FIG. 4A showing the interconnecting/welding areas between the expanded beads.

FIG. 5A shows the SEM image of a section of the TPU sample obtained with the conditions shown in Example 3.

FIG. 5B shows a magnification of FIG. 5A showing the interconnecting/welding areas between the expanded beads.

FIG. 6A shows the SEM image of a section of the TPU sample obtained with the conditions shown in Example 4.

FIG. 6B shows a magnification of FIG. 6A showing the interconnecting/welding areas between the expanded beads.

FIG. 7A shows the results, in terms of stress-strain diagrams, obtained from the mono axial static compression tests of the TPU samples produced in examples 1-4.

FIG. 7B shows a magnification in the linear area at small deformations of the results, in terms of stress-strain diagrams, obtained from the static single axial compression tests of the TPU samples produced in examples 1-4.

FIG. 8A shows an optical microscope image of a section of a single PS granule, obtained under the conditions shown in Example 6.

FIGS. 8B and 8C show optical microscopic images of sections at different magnification of the sintered PS sample obtained under the conditions shown in Example 6.

FIG. 9A shows an optical microscope image of a section of a single PS granule, obtained under the conditions shown in Example 7.

FIGS. 9B and 9C show optical microscopic images of sections at different magnification of the sintered PS sample obtained under the conditions shown in Example 7.

FIGS. 10A and 10B show optical microscopic images of sections at different magnification of the sintered PS sample obtained under the conditions shown in Example 8.

FIGS. 11A, 11B and 11C show optical microscopic images of sections at different magnification of the sintered PS sample obtained under the conditions shown in Example 8.

FIG. 12A shows the results, in terms of stress-strain diagrams, obtained from the single axial static compression tests of the samples produced in examples 6 and 7.

FIG. 12B shows a magnification in the linear area at small deformations of the results, in terms of stress-strain diagrams, obtained from the static mono axial compression tests of the samples produced in examples 6 and 7, relative to PS-based foam at a density of 230 g/cm³.

FIG. 12C shows the results, in terms of stress-strain diagrams, obtained from the single axial static compression tests of the samples produced in examples 8 and 9.

FIG. 12D shows a magnification in the linear area at small deformations of the results, in terms of stress-strain diagrams, obtained from the static mono axial compression tests of the samples produced in examples 8 and 9, relative to PS-based foam at density 110 g/cm³.

FIG. 13 shows the SEM image of a section of a single expanded PP granule, obtained under the conditions shown in Example 11.

FIG. 14A shows the SEM image of a section of the of the resulting foamed PP beads obtained under the conditions shown in Example 12.

FIG. 14B shows a detail of the welding zone of the beads of FIG. 14A.

FIG. 14C shows a detail of the welding zone of the beads of FIG. 14A.

FIG. 15 shows the plots of a DSC test conducted on the resulting beads foamed according to the procedure described in Example 12.

FIG. 16 shows the SEM image of a section of a single expanded PLA granule, obtained under the conditions shown in Example 13.

FIG. 17 shows the SEM image of a section of a single expanded PLA granule, obtained under the conditions shown in Example 14.

FIG. 18 shows the SEM image of a section of a single expanded PLA granule, obtained under the conditions shown in Example 15.

FIG. 19 shows the SEM image of a section of a single PLA granule, obtained under the conditions shown in Example 16.

FIG. 20 shows the SEM image of a section of a single PLA granule, obtained under the conditions shown in Example 17.

FIG. 21 shows the SEM image of a section of a single PLA granule, obtained under the conditions shown in Example 18.

FIG. 22 shows the plots of a DSC test conducted on the resulting beads foamed according to the procedure described in Example 12.

### DETAILED DESCRIPTION OF THE INVENTION

The expression “polymeric material” means a polymeric material comprising a thermoplastic or thermosetting homo-polymer or co-polymer, or mixtures thereof.

The expression “foamed polymeric material” refers to a polymeric material in which bubbles have been formed, for example by means of a blowing agent.

The expression “blowing agent” means a substance capable of causing expansion of the polymeric material by the formation of bubbles within the polymeric material.

The expression “expandable polymeric material” means a polymeric material capable of absorbing a blowing agent at a certain temperature and under pressure, allowing bubbles to nucleate when pressure is released and resisting elongational stress during bubble growth until solidification.

The term “granules” indicates polymeric particles of substantially spherical, spheroidal, cylindrical or ellipsoidal shape, preferably with average variations between maximum and minimum diameter lower than 20%, preferably lower than 15%.

The expression “multi-layer structure” means a structure comprising two or more layers, preferably three or more layers.

The expression “homogeneous composition” means a composition consisting of a polymeric material of uniform and constant composition in all its points.

The term “discontinuity” means a clear and distinct boundary between two adjacent layers typical of composite materials made by hot joining or with adhesives of two layers of different structure made separately.

The term “density” means the ratio between the weight of a given element and the volume occupied by that element, in particular of a layer or area of the foamed polymeric material of the present invention.

The term “average density” means the apparent density of an element, in particular of the foamed polymeric material of the present invention, comprising areas and/or layers with different densities and/or morphology.

The term “morphology” indicates the shape, size and number per unit volume of the bubbles formed within the foamed polymeric material.

The expression “welding layer(s)” indicates the inter-bead bonding line(s) between sintered expanded beads.

The first object of the present invention is a process to prepare a foamed polymeric material comprising sintered expanded beads by the use of one or more blowing agents, characterized in that this process comprises the following steps:
providing an expandable polymeric material in the form of granules,
solubilizing with a time-varying pressure profile said one or more blowing agents in the expandable polymeric material,
expanding said granules to form said expanded beads by instantly releasing the pressure or by pressure release and subsequent heating, and
sintering together said expanded beads, preferably at a temperature higher than 30° C.

According to the first object of the invention, said polymeric material is preferably selected from the group consisting of thermoplastic or thermosetting polymeric materials.

Advantageously, said thermoplastic polymeric materials are selected from the group comprising polyolefins, polyurethanes, polyesters and polyamides.

Preferably, said thermosetting polymeric materials are selected from the group comprising polyurethanes, epoxy resins, melamine resins, polyphenols, and polyimides.

Preferably, said polymeric materials are polymers and copolymers of styrene, ethylene, propylene, and other olefins, such as polystyrene, polyethylene, and polypropylene. Optionally, said polymeric materials can comprise one or more co-monomers. Co-monomers can include, for example, alkylstyrene, divinylbenzene, acrylonitrile, diphenylether, alpha-methylstyrene, or combinations thereof. As an example, the polymeric material can comprise from about 0% by weight to about 30% by weight, preferably from about 0.1% by weight to about 15% by weight, and more preferably from about 1% by weight to about 10% by weight of co-monomer.

Preferably, polymeric materials can show a molecular weight Mw (measured by GPC) from about 10,000 Dalton to about 500,000 Dalton, more preferably from about 150,000 Dalton to about 400,000 Dalton, and even more preferably from about 200,000 Dalton to about 350,000 Dalton.

Advantageously, polymeric materials show a flow index, measured according to ASTM D 1238 at a temperature of 200° C. and a load of 10kg, between 1.0 and 20 g/10 min.

According to the first object of the invention, said granules have a maximum diameter between 0.1 mm and 10 mm, preferably between 0.5 mm and 5 mm.

According to the first object of the invention, said time-varying pressure profile preferably varies over time in a periodic or non-periodic manner.

According to the first object of the invention, said time-varying pressure profile preferably varies over time in a periodical way with a waveform selected from the group consisting of the sinusoidal, triangular, square, sawtooth type, or combinations thereof.

According to the first object of the invention, said time-varying pressure profile preferably varies over time in a non-periodic way following a linear, broken, curvilinear, parabolic, exponential, impulsive profile or combinations thereof. According to the first object of the invention, said time-varying pressure profile preferably varies from a minimum pressure equal to atmospheric pressure to a maximum of 300 bar, more preferably from atmospheric pressure to 250 bar, and advantageously from atmospheric pressure to 200 bar.

According to the first object of the invention, said time-varying pressure profile preferably comprises at least one step with a pressure profile increasing over time and at least one step with a pressure profile decreasing over time.

According to the first object of the invention, said time-varying pressure profile can advantageously comprise at least one step with a pressure profile constant over time.

According to the first object of the invention, the solubilization step is conducted with a blowing agent or a mixture of two or more blowing agents, preferably with a mixture of two blowing agents. The solubilization step can be advantageously carried out by varying the concentration of the blowing agent over time. In particular, the concentration of the blowing agent in the blowing agent mixture may vary over time.

According to the first object of the invention, the solubilization step is preferably conducted at a temperature between 100° and 350° C., more preferably between 120° and 250° C., and advantageously between 130° and 200° C. In another embodiment of the first object of the invention, such as when using polylactic acid (PLA), poly(methyl methacrylate) (PMMA), polycaprolactone (PCL) and other similar polymers, the solubilization step is preferably conducted at a temperature between −50° and 200° C., more preferably between 0° and 150° C., and advantageously between 20° and 100° C.

According to the first object of the invention, one or more blowing agents are selected from the group consisting of inert gases, carbon dioxide, and aliphatic hydrocarbons (linear, branched or cyclic) substituted or unsubstituted having from 3 to 8 carbon atoms.

The blowing agent is advantageously selected from the group consisting of nitrogen, carbon dioxide, n-butane, iso-butane, n-pentane, and iso-pentane. Preferably, the substituted aliphatic hydrocarbons include halogenated hydrocarbons, in particular chlorocarbons, chlorofluorocarbons and fluorocarbons, such as, for example, 1,1,1,2-tetrafluoroethane (Freon R-134a), 1,1-difluoroethane (Freon R-152a), difluoromethane (Freon R-32), pentafluoroethane (Freon R-125), sulphur hexafluoride.

According to the first object of the invention, the expansion step is performed, in a first embodiment, by instantly releasing the pressure or, in a second alternative embodiment, by pressure release and subsequent heating.

As known in the art, according to the first embodiment, the formation of the expanded beads will occur at the same time of instantaneous pressure release when using an expandable polymeric material in a molten, softened or swollen state.

As also known in the art, according to the second embodiment, the formation of the expanded beads will occur at the time of heating when using an expandable polymeric material in a solid state, such as, for example, glassy or semi-crystalline.

According to the first object of the invention, the sintering step is advantageously performed at a temperature higher than the glass transition temperature of said expandable polymeric material. Preferably, the sintering step is performed at a temperature between 20° C. and 250° C., more preferably between 50° C. and 150° C., such as for example, between 40° C. and 230° C., preferably between 60° C. and 200° C. for polylactic acid, between 50° C. and 180° C., preferably between 70° C. and 160° C. for poly(methyl methacrylate), between 25° C. and 100° C., preferably between 35° C. and 90° C. for polycaprolactone, between 90° C. and 130° C., preferably between 100° C. and 110° C. for polystyrene, between 90° C. and 130° C., preferably between 100° C. and 110° C. for thermoplastic polyurethane, and between 110° C. and 160° C., preferably between 120° C. and 140° C. for polypropylene.

A second object of the present invention is represented by a foamed polymeric material comprising sintered expanded beads obtained with the process according to the first object of the present invention, where said foamed polymeric material, for the same average density, shows mechanical and functional properties dependent on said time-varying pressure profile.

In other words, the variation of the pressure profile over time achieved by the process of this invention creates a concentration profile of the blowing agent(s) that leads to a density and/or morphology profile on which the mechanical and functional properties of the foamed polymeric material depend.

In particular, in accordance with the second object of the present invention, said foamed polymeric material, for the same average density, shows values of mechanical properties greater or lesser than those obtained with a uniform pressure profile.

Advantageously, in accordance with the second object of the present invention, said foamed polymeric material, for the same average density, shows values of mechanical properties greater than those obtained with a uniform pressure profile when the time-varying pressure profile comprises a first saturation step with pressure greater than the pressure of a subsequent second saturation step.

Alternatively, according to the second object of the present invention, said foamed polymeric material, for the same average density, shows values of mechanical properties lower than those obtained with a uniform pressure profile when the time-varying pressure profile comprises a first saturation step with pressure lower than the pressure of a second saturation step.

Similarly, the Applicant found that the variation in the composition of the blowing gas can be appropriately adjusted by time-varying the partial pressures of two or more blowing agents (such as nitrogen and carbon dioxide) characterized by different diffusivity and solubility.

In this way, in accordance with the second object of the present invention, it is possible to obtain a foamed polymeric material that, for the same average density, shows values of mechanical properties higher or lower than those obtained with a uniform pressure profile, by time-varying the partial pressures of two or more blowing agents (such as nitrogen and carbon dioxide) characterized by different diffusivity and solubility.

In particular, said foamed polymeric material, for the same average density, shows values of mechanical properties greater than those obtained with a uniform pressure profile when the time-varying pressure profile comprises a first saturation step with a partial pressure greater than one or more blowing agents with greater solubility and a subsequent second saturation step with a partial pressure greater than one or more blowing agents with less solubility.

Alternatively, said foamed polymeric material, for the same average density, shows values of mechanical properties lower than those obtained with a uniform pressure profile when the time-varying pressure profile comprises a first saturation step with a partial pressure greater than one or more blowing agents with less solubility and a subsequent second saturation step with a partial pressure greater than one or more blowing agents with greater solubility.

A third object of the present invention is represented by a foamed polymeric material comprising sintered expanded beads characterized by welding layers between said sintered expanded beads, said welding layers having density greater or lower than the average density of said foamed polymeric material.

Preferably, said welding layers show a thickness between 0.01 μm and 1000 μm, more preferably between 0.1 μm and 500 μm, and even more preferably between 1 μm and 100 μm.

Advantageously, in accordance with the second and third aspects of the present invention, said sintered expanded beads comprise a welding layer and an inner portion of said welding layer comprising at least one expanded layer, where the density of said welding layer is greater than the density of said inner portion.

Alternatively, in accordance with the second and third aspects of the present invention, said sintered expanded beads comprise a welding layer and an inner portion of said welding layer comprising at least one expanded layer, where the density of said welding layer is lower than the density of said inner portion.

In accordance with the second and third aspects of the present invention, said sintered expanded beads may advantageously comprise an inner portion of said welding layer comprising at least two layers with different density and/or morphology and show a gradual variation of density and/or morphology.

Said sintered expanded beads advantageously comprise an inner portion of said welding layer comprising at least one layer with lower density and finer morphology and at least one layer with higher density and coarser morphology.

Said sintered expanded beads advantageously comprise an inner portion of said welding layer comprising at least one layer with lower density and coarser morphology and at least one layer with higher density and finer morphology.

Advantageously, said sintered expanded beads comprise an inner portion of said welding layer comprising at least one layer with lower density and at least one layer with higher density, with uniform morphology.

Advantageously, said sintered expanded beads comprise an inner portion of said welding layer comprising at least one layer with coarser morphology and at least one layer with finer morphology, with uniform density.

Advantageously, the interface between said at least two layers with different density and/or morphology does not show discontinuity of morphology and/or density.

Further, the Applicant noted that the sintered expanded beads according to the second and third object of the present invention had an inner portion comprising layers with different crystalline structure and/or degree of crystallinity as a consequence of the different foaming extent and treatment with different blowing agents.

More in particular, said sintered expanded beads comprises an inner portion comprising at least two layers with a different degree of crystallinity, such as for example an inner layer in which the degree of crystallinity is higher than the outer layer, or viceversa.

Accordingly, the foamed polymeric material according to the second and third object of the present invention comprises sintered expanded beads characterized by an inner portion comprising at least two layers with different degree of crystallinity.

Further, the Applicant also noted that the welding layers of the sintered expanded beads had a degree of crystallinity different from the average degree of crystallinity of the foamed polymeric material.

Accordingly, the foamed polymeric material according to the second and third object of the present invention comprises sintered expanded beads characterized by welding layers between said sintered expanded beads with a degree of crystallinity higher or lower than the average degree of crystallinity of said foamed polymeric material.

The polymeric material according to the second and third object of the present invention is suitable for use in the production of manufactured articles of complex shape with improved mechanical properties, in particular with higher elastic modulus (or stiffness) for the same density, or with higher lightness for the same elastic modulus (or stiffness). A fourth object of this invention is represented by a manufactured article made in whole or in part from the polymeric material according to the second or third object of the present invention.

In particular, in accordance with the fourth object of the present invention, said manufactured article is represented, for example, by protection systems (shin guards, back guards, shoulder and elbows guards, knee pads, shells and pads, bulletproof vests), helmets (bicycle, motorbike, work and combat), orthopedic prostheses, dental prostheses, epidermis prostheses, tissue engineering scaffolds, sound absorption and insulation sheets and systems, thermal insulation sheets and systems, soles and elements for sports footwear, car panels, sports equipment, furniture, packaging, membranes and filtration systems, sacrificial foams for ceramic materials and porous metals, foams for diffusers and aerators, biomedical systems, pads and patches for controlled drug delivery, progressive mechanical response systems, progressive functional response systems, electromagnetic shielding systems, catalytic systems, aerospace and aeronautic foams, foams for optoelectronics, flotation systems, frames and chassis, and spectacle frames.

This invention will now be illustrated with reference to materials and methods described by way of explanation, but not limitation, in the following experimental part.

### Experimental Part

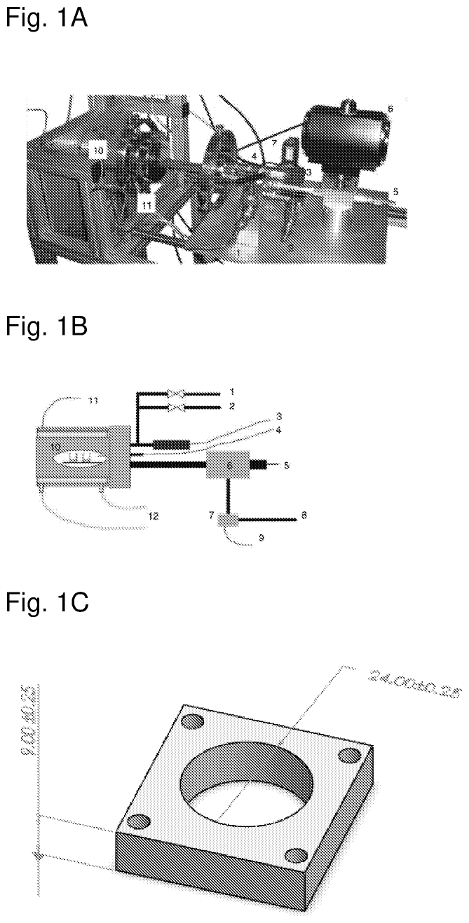

A batch expansion system illustrated in FIG. 1 was used to prepare the foam samples, details of which are shown below. FIG. 1 shows a photograph (FIG. 1A) and a diagram (FIG. 1B) of the discontinuous foaming apparatus used in this invention.

The reactor is cylindrical, temperature-controlled and pressurized, with a volume of 0.3 L (HiP, model BC-1). The reactor has been modified to allow measurement and control of the interesting process parameters.

For temperature control, an electric heater (11) was used as heating element and a heat exchanger with an oil bath (12) was used as cooling element.

The heater (11) and the heat exchanger (12) have been controlled by a PID temperature controller (Ascon, model X1), which reads the temperature inside the reactor using a Pt100 probe (4).

A Schaevitz pressure transducer, model P943 (3) was used to measure the pressures during the saturation step and to record the pressure trend during the release of the blowing agent. The valve (1) is connected to the blowing gas supply while the valve (2) is connected to a vacuum pump.

The pressure relief system consists of a HiP ball valve, model 15-71 NFB (5), a HiP electromechanical actuator, model 15-72 NFB TSR8 (6), and a solenoid valve (7) connected to the compressed air line (8) and cable (9) for the solenoid valve actuation signal (7). This system allows reproducibility in valve opening. The pressure trend over time during pressure release, P (t), was recorded using a DAQ data acquisition system PCI6036E, National Instruments, Austin, Tex., USA.

The pressure program is controlled by the Teledyne ISCO volumetric pump model 500D (Lincoln Neb., USA). Through the serial interface of the pump controller it is possible to control the pump via a computer and implement any pressure program. In addition, the controller can control up to four pumps for different fluids.

The realization of a variable condition of the solubilization step can occur through a variation of the solubilization pressure of the blowing agent or several blowing agents, with a periodic trend (e.g. a triangular or sinusoidal wave), or with a non-periodic trend (e.g. a linear or curvilinear profile), as described by the following examples.

### EXAMPLE 1

### Comparison

In this example the polymer used is a thermoplastic polyurethane (TPU), code 3080au, supplied by Great Eastern Resins Industrial Co., Ltd. (GRECO) (Taichung City, Taiwan) with an average molecular weight of 500 kDa and a density of 1.14 g/cm³.

The material is supplied in ellipsoidal TPU granules with a characteristic size of about 3 mm.

Some granules, with a total fixed weight of 0.95 g, are housed inside a cylindrical steel mold with a diameter of 25 mm and a thickness of 9 mm (FIG. 1C), then closed with two flat steel plates and inserted inside the reactor of the batch expansion plant illustrated in FIG. 1 and described above, at room temperature. The reactor was then closed and brought to a temperature of 140° C.

The system was then subjected to the blowing gas solubilization step (N₂/CO₂ mixture, 80/20 v/v) using the uniform pressure profile described in Table 1.

TABLE 1

| | Initial pressure | Final pressure | Duration |
|---|---|---|---|
| | (bar) | (bar) | (minutes) |
| Step 1 (pressurization) | 0 | 110 (N₂/CO₂) | 0.2 |
| Step 2 (saturation) | 110 (N₂/CO₂) | 110 (N₂/CO₂) | 90 |
| Step 3 (release/expansion) | 110 (N₂/CO₂) | 0 | 0.0018 |

As shown in Table 1, before release step 3, the uniform pressure profile comprised two steps:
In step 1, the pressure of the blowing gas N₂/CO₂ was brought from atmospheric pressure to 110 bar with a linear ramp in a time of 0.2 minutes (12 seconds);
In step 2, the pressure of the N₂/CO₂ blowing gas mixture was kept at 110 bar for 90 minutes to allow complete solubilization of the blowing agent.

In step 3 the pressure was released at a speed of 1000 bar/s for foaming.

Immediately before pressure release the concentration profile of the blowing agent within the individual TPU granules is flat (constant concentration in space).

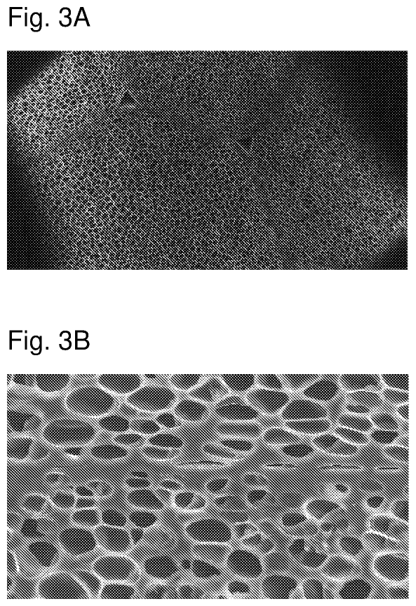

At the time of expansion, which follows the release of pressure at a temperature of 140° C., the individual granules expand (forming the expanded beads) with a morphology of the foam dependent on the concentration of the blowing agent. In this case, the morphology is uniform as a result of the uniform blowing agent concentration. By expanding, the beads are sintered with the adjacent beads (FIG. 3A), forming welding lines, details of which are shown in FIG. 3B.

The set of beads then fills the available volume in the cylindrical mold, forming a cylindrical expanded sintered sample of the same size as the mold.

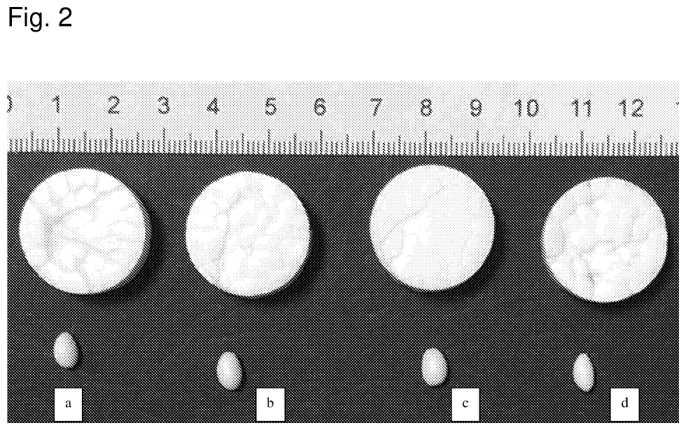

FIG. 2a) shows the cylindrical expanded sintered sample and expanded bead obtained by the same procedure.

### EXAMPLE 2

### Invention

A sample of TPU similar in geometry and positioning in the mold to that described in Example 1 was housed at room temperature in the reactor of the batch expansion system shown in FIG. 1 and described above. The reactor was then closed and brought to a temperature of 140° C.

The system was then subjected to the solubilization step using two blowing gases (the first is a mixture of N₂/CO₂ with 80/20 v/v composition; the second is He) using the time-varying pressure profile described in Table 2.

TABLE 2

| | Initial pressure | | Final pressure | | Duration |
|---|---|---|---|---|---|
| | (bar) | | (bar) | | (minutes) |
| Step 1 (pressurization) | 0 | | 140 | (N₂/CO₂) | 0.2 |
| Step 2 (saturation) | 140 | (N₂/CO₂) | 140 | (N₂/CO₂) | 90 |
| Step 3 (gas exchange | 140 | (N₂/CO₂) | 150 | (He) | 2 |
| and partial | | | | | |
| solubilization) | | | | | |

| | | | | |
|---|---|---|---|---|
| Step 4 (Release/ | 150 | (He) | 0 | 0.0018 |
| Expansion) | | | | |

As shown in Table 2, before release step 4, the time-varying pressure profile comprised three steps:
In step 1, the pressure of the blowing gas N₂/CO₂ was brought from atmospheric pressure to 140 bar with a linear ramp in a time of 0.2 minutes (12 seconds);
In step 2, the pressure of the N₂/CO₂ blowing gas mixture was kept at 140 bar for 90 minutes,
in step 3, the pressure of the first blowing gas (N₂/CO₂ mixture) was decreased from 140 to 0 bar in a time of 2 minutes; at the same time, in the same step, the pressure was first balanced using the second blowing gas (He), and then increasing the final pressure to 150 bar.

At the end of step 3 the pressure was released at a maximum speed of 1000 bar/s for foaming.

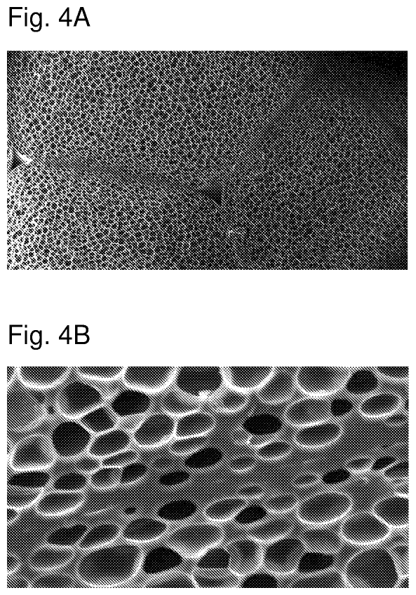

As shown in FIG. 4A, similarly to example 1, during expansion each bead sinters with adjacent beads, forming welding lines, details of which are shown in FIG. 4B. The set of beads then fills the available volume in the cylindrical mold, forming a cylindrical expanded sintered sample of the same size as the mold.

FIG. 2b) shows the cylindrical expanded sintered sample and expanded bead obtained by the same procedure.

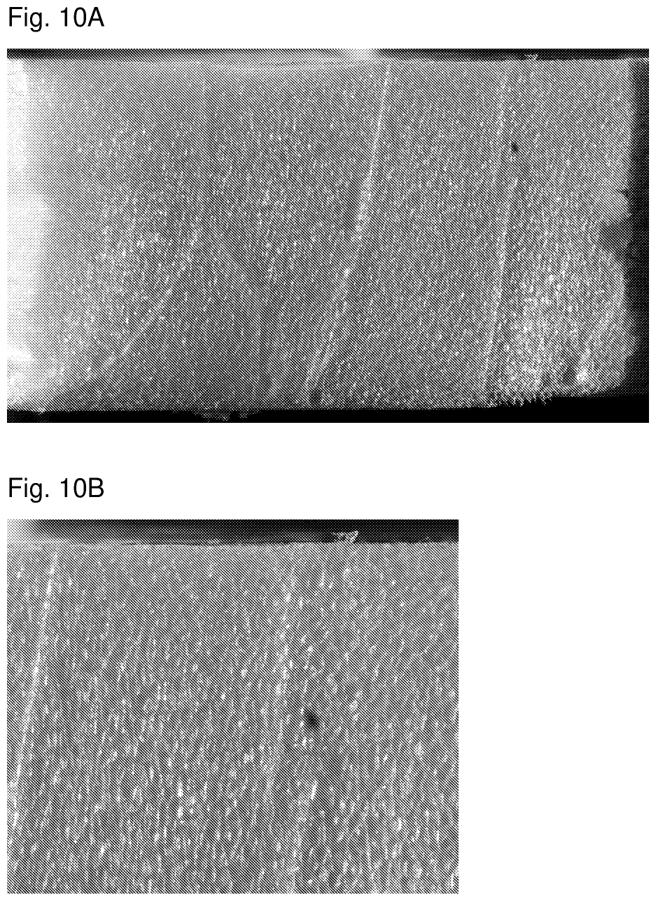

As described in patent application IT 102018000004727, example 9 (FIGS. 10A and 10B), a solubilization procedure of this type generates the formation of a dense layer (with a low or zero degree of expansion) at the periphery of the sample. This dense layer is visible in FIGS. 4A and 4B, evident when comparing with the uniform case of FIGS. 3A and 3B, where the welding layer between the beads is smaller.

Using specific solubilization programs, it is possible to design the number, thicknesses, morphologies and densities of the different layers, as described in IT 102018000004727, and as detailed in the following examples.

### EXAMPLE 3

### Invention

A sample of TPU similar in geometry and positioning in the mold to that described in Example 1 was housed at room temperature in the reactor of the batch expansion system shown in FIG. 1 and described above. The reactor was then closed and brought to a temperature of 140° C.

The system was then subjected to the solubilization step using two blowing gases (the first is a mixture of N₂/CO₂ with 80/20 v/v composition; the second is He) using the time-varying pressure profile described in Table 3.

TABLE 3

| | Initial pressure | | Final pressure | | Duration |
|---|---|---|---|---|---|
| | (bar) | | (bar) | | (minutes) |
| Step 1 (pressurization) | 0 | | 100 | (N₂/CO₂) | 0.2 |
| Step 2 (saturation) | 100 | (N₂/CO₂) | 100 | (N₂/CO₂) | 90 |
| Step 3 (gas exchange | 100 | (N₂/CO₂) | 100 | (He) | 5 |
| and partial | | | | | |
| solubilization) | | | | | |

| | | | | |
|---|---|---|---|---|
| Step 4 (Release/ | 100 | (He) | 0 | 0.0018 |
| Expansion) | | | | |

As shown in Table 3, before release step 4, the time-varying pressure profile comprised three steps:
In step 1, the pressure of the blowing gas N₂/CO₂ was brought from atmospheric pressure to 100 bar with a linear ramp in a time of 0.2 minutes (12 seconds);
In step 2, the pressure of the N₂/CO₂ blowing gas mixture was kept at 100 bar for 90 minutes,
in step 3, the pressure of the first blowing gas (mixture N₂/CO₂) was decreased from 100 to 0 bar in a time of 2 minutes; at the same time, in the same step, the pressure was balanced, always keeping the total pressure equal to 100 bar, using the second blowing gas He.

At the end of step 3 the pressure was released at a maximum speed of 1000 bar/s for foaming.

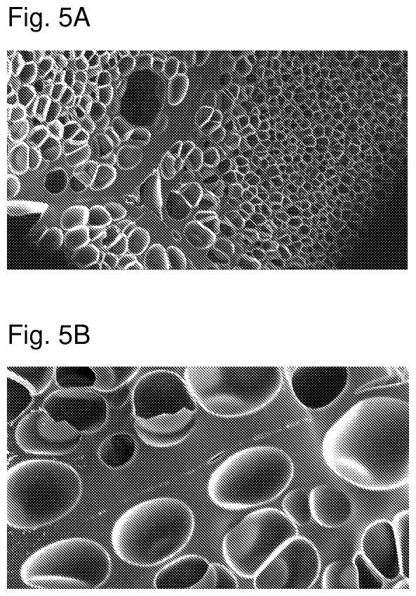

As shown in FIG. 5A, similarly to example 1, during expansion each bead sinters with adjacent beads, forming welding lines, details of which are shown in FIG. 5B.

The set of beads then fills the available volume in the cylindrical mold, forming a cylindrical sintered expanded sample of the same size as the mold. FIG. 2c) shows the cylindrical sintered expanded sample and the expanded bead using the same procedure.

Compared to example 2, in this case the solubilization step with the He is prolonged (5 minutes instead of 2), which led to a thickening of the non-expanded layer, as shown by the images in FIGS. 5A and 5B (compare with the corresponding images 4A and 4B of the gradient sintered product with thinner outer layer and with the corresponding images 3A and 3B of the uniform sintered product).

### EXAMPLE 4

### Invention

A sample of TPU similar in geometry and positioning in the mold to that described in Example 1 was housed at room temperature in the reactor of the batch expansion system shown in FIG. 1 and described above. The reactor was then closed and brought to a temperature of 140° C.

The system was then subjected to the blowing gas solubilization step (N₂/CO₂ mixture, 80/20 v/v) using the time-varying pressure profile described in Table 4.

TABLE 4

| | Initial pressure | Final pressure | Duration |
|---|---|---|---|
| | (bar) | (bar) | (minutes) |
| Step 1 (pressurization) | 0 | 150 (N₂/CO₂) | 0.2 |
| Step 2 (saturation) | 150 (N₂/CO₂) | 150 (N₂/CO₂) | 90 |
| Step 3 (pressurization) | 150 (N₂/CO₂) | 220 (N₂/CO₂) | 0.0018 |
| Step 4 (saturation) | 220 (N₂/CO₂) | 220 (N₂/CO₂) | 2 |
| Step 5 (Release/Expansion) | 220 (N₂/CO₂) | 0 | 0.0018 |

As shown in Table 4, before release step 5, the time-varying pressure profile comprised four steps:
In step 1, the blowing gas pressure (N₂/CO₂) was brought from atmospheric pressure to 150 bar with a linear ramp in a time of 0.2 minutes (12 seconds);
In step 2, the blowing gas pressure (N₂/CO₂) was maintained at 150 bar for 90 minutes;
In step 3, the pressure of the blowing gas (N₂/CO₂) was suddenly (0.1 seconds) flowed from 150 to 220 bar;
In step 4, the blowing gas pressure (N₂/CO₂) was maintained at 220 bar for 2 minutes.

At the end of step 4 the pressure was released at a maximum speed of 1000 bar/s for foaming.

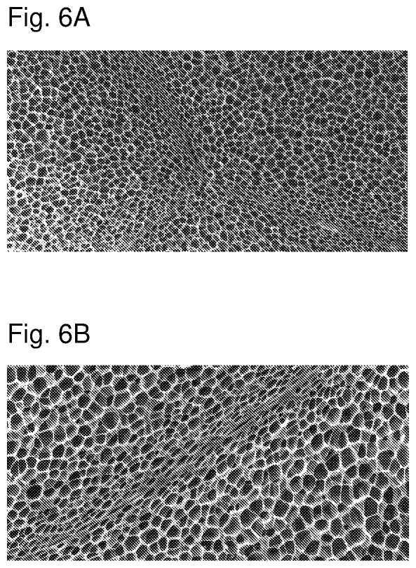

As shown in FIG. 6A, similarly to example 1, during expansion each bead sinters with adjacent beads, forming welding lines, details of which are shown in FIG. 6B.

The set of beads then fills the available volume in the cylindrical mold, forming a cylindrical sintered expanded sample of the same size as the mold. FIG. 2d) shows the cylindrical sintered expanded sample and the expanded bead using the same procedure.

Compared to the previous cases in examples 2 and 3, beads have a reverse density gradient, more expanded in the outer layers than the inner layers. Furthermore, as shown in FIGS. 6A and B, the welding lines are characterized by the absence of dense layers.

### EXAMPLE 5

### Mechanical Properties

The expanded cylindrical samples resulting from the above experiments (representative images of which are shown in FIG. 2) were subjected to static mono-axial compression tests using the METRAVIB DMA+1000 (ACOEM) cylindrical plate configuration as a measuring instrument. Each sample was subjected to compression with a displacement speed of 0.3 mm/min up to 50% deformation.

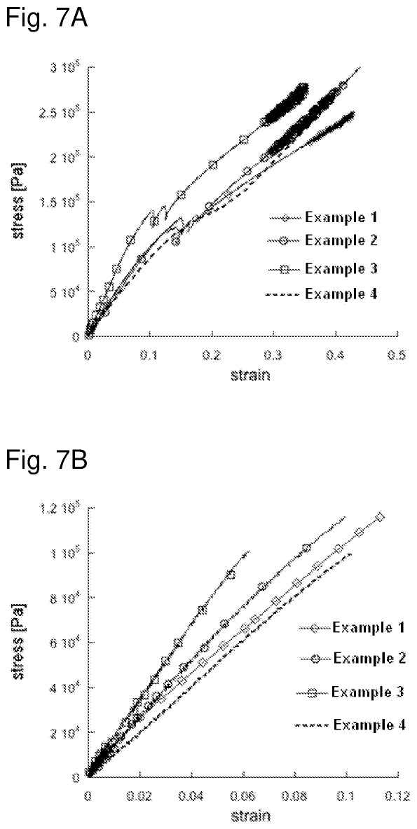

FIGS. 7A and 7B represent the curves obtained from the acquired data. In particular, we highlight the variation of the elastic modulus in compression of the different sintered foams, all with an average density of 230 kg/m³. The following Table 5 shows the elastic modulus values for the different examples described.

TABLE 5

| Sample | modulus of elasticity (MPa) |
|---|---|
| example 1 | 1.01 |
| example 2 | 1.12 |
| example 3 | 1.32 |
| example 4 | 0.98 |

The cylindrical samples in examples 2 and 3, resulting from gradient beads less expanded in the outermost layer, were found to have greater stiffness, for the same average density, than the sample in example 1.

On the contrary, the cylindrical sample in example 4, resulting from gradient beads more expanded in the outermost layer, was found to have a lower stiffness, for the same average density, than the sample in example 1.

### EXAMPLE 6

### Comparison

In this example the polymer used is a polystyrene (PS), code N2380, supplied by Versalis SpA (Mantua, Italy) with an average molecular weight, density and melt flow index of 300 kDa, 1.05 g/cm3 and 2.0 g/10 min at 200° C. and 10 kg, respectively.

The material is supplied in ellipsoidal PS granules with a characteristic size of about 3 mm. Some granules, with a total fixed weight of 0.95 g, are housed inside a cylindrical steel mold with a diameter of 25 mm and thickness of 9 mm (FIG. 1C), then closed with a flat steel plate and inserted inside the reactor of the batch expansion plant illustrated in FIG. 1 and described above, at room temperature. The reactor was then closed and brought to a temperature of 110° C.

The system was then subjected to the blowing gas (CO₂) solubilization step using the uniform pressure profile described in Table 6.

TABLE 6

| | Initial pressure | Final pressure | Duration |
|---|---|---|---|
| | (bar) | (bar) | (minutes) |
| Step 1 (pressurization) | 0 | 130 | 0.2 |
| Step 2 (saturation) | 130 | 130 | 90 |
| Step 3 (Release/Expansion) | 130 | 0 | 0.0018 |

As shown in Table 6, before release step 3, the uniform pressure profile comprised two steps:
In step 1, the pressure of the blowing gas (CO₂) was brought from atmospheric pressure to 130 bar with a linear ramp in a time of 0.2 minutes (12 seconds);
In step 2, the blowing gas pressure (CO₂) was maintained at 130 bar for 90 minutes;

At the end of step 2, the pressure was released at a maximum speed of 1000 bar/s for foaming.

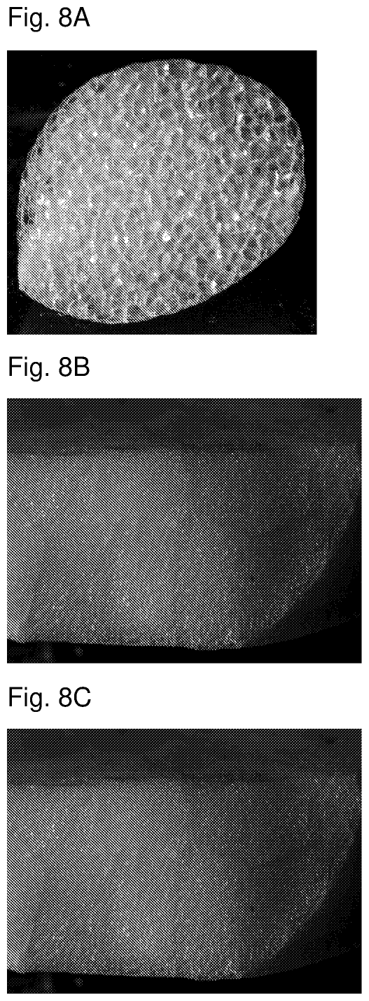

In FIG. 8A, a single expanded granule is shown, made according to the same procedure described in Table 6 and in which the uniform morphology can be appreciated. Similarly to example 1, using the mold and using for each mold 0.95 g of polymer, during expansion each bead sinters with the adjacent beads, forming welding lines, the detail of which is shown in FIG. 8B and even more detailed in FIG. 8C. As in the case of FIGS. 3A and 3B, a thin sintering area between the different beads and a uniform morphology are shown as well.

### EXAMPLE 7

### Invention

A sample of PS similar in geometry and positioning in the mold to that described in Example 6 was housed at room temperature in the reactor of the batch expansion system shown in FIG. 1 and described above. The reactor was then closed and brought to a temperature of 110° C.

The system was then subjected to the blowing gas (CO₂) solubilization step using the time-varying pressure profile described in Table 7.

TABLE 7

| | Initial pressure | Final pressure | Duration |
|---|---|---|---|
| | (bar) | (bar) | (minutes) |
| Step 1 (pressurization) | 0 | 130 | 0.2 |
| Step 2 (saturation) | 130 | 130 | 90 |
| Step 3 (pressurization) | 130 | 100 | 5 |
| Step 4 (saturation) | 100 | 100 | 2 |
| Step 5 (release/expansion) | 100 | 0 | 0.0018 |

As shown in Table 7, before release step 5, the time-varying pressure profile comprised four steps:
In step 1, the blowing gas pressure was brought from atmospheric pressure to 130 bar with a linear ramp in a time of 0.2 minutes (12 seconds);
In step 2, the blowing gas pressure was maintained at 130 bar for 90 minutes;
In step 3, the blowing gas pressure was increased from 130 to 100 bar in 5 minutes;
In step 4, the blowing gas pressure was maintained at 100 bar for 2 minutes.

At the end of step 4 the pressure was released at a maximum speed of 1000 bar/s for foaming.

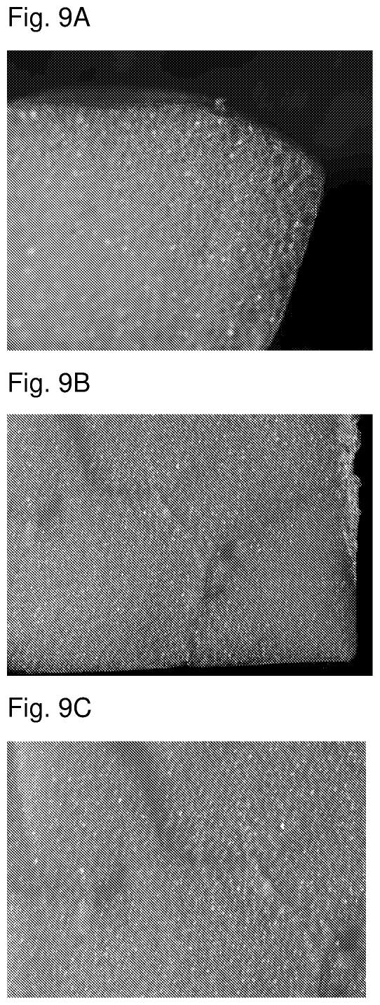

FIG. 9A shows a single expanded granule, made according to the same procedure described in Table 7 and in which the gradient morphology can be appreciated, with denser outer layers and coarser morphology, due to the lower gas concentration. Similarly to example 1, using the mold and using for each mold 0.95 g of polymer, during expansion each bead sinters with the adjacent beads, forming welding lines, whose detail is shown in FIG. 9B and even more detailed in FIG. 9C. Compared to the case of example 6, a gradient morphology at the interface with a coarser morphology and higher density going from the center of the beads to the edge is shown.

### EXAMPLE 8

### Comparison

A sample of PS similar, for geometry and positioning in the mold, to that described in Example 6, but in a smaller quantity, 0.42 g, was housed at room temperature in the reactor of the batch expansion system shown in FIG. 1 and described above. The material is supplied in ellipsoidal PS granules with a characteristic size of approximately 3 mm. Some granules, with a total fixed weight of 0.42 g, unlike the two previous examples where 0.95 g were used to assess the effects of foam density on the foam properties obtained by sintering gradient foam beads, were housed in a 25 mm diameter, 9 mm thick cylindrical steel mold (FIG. 1C), then closed with a flat steel plate and inserted into the reactor of the batch expansion plant shown in FIG. 1 and described above, at room temperature. The reactor was then closed and brought to a temperature of 120° C.

The system was then subjected to the blowing gas (CO₂) solubilization step using the uniform pressure profile described in Table 8.

TABLE 8

| | Initial pressure | Final pressure | Duration |
|---|---|---|---|
| | (bar) | (bar) | (minutes) |
| Step 1 (pressurization) | 0 | 130 | 0.2 |
| Step 2 (saturation) | 130 | 130 | 90 |
| Step 3 (Release/Expansion) | 130 | 0 | 0.0018 |

As shown in Table 8, before release step 3, the uniform pressure profile comprised two steps:
In step 1, the pressure of the blowing gas (CO₂) was brought from atmospheric pressure to 130 bar with a linear ramp in a time of 0.2 minutes (12 seconds);
In step 2, the blowing gas pressure (CO₂) was maintained at 130 bar for 90 minutes;

At the end of step 2, the pressure was released at a maximum speed of 1000 bar/s for foaming.

In FIG. 10A, a photo of the resulting sintered foam is shown, with a detail of the welding area shown in FIG. 10B. As in the case of FIGS. 3A and 3B, a thin sintering area between the different beads and a uniform morphology is shown as well.

### EXAMPLE 9

### Invention

A sample of PS similar in geometry and positioning in the mold to that described in Example 8 was housed at room temperature in the reactor of the batch expansion system shown in FIG. 1 and described above. The reactor was then closed and brought to a temperature of 120° C.

The system was then subjected to the blowing gas (CO₂) solubilization step using the time-varying pressure profile described in Table 9.

TABLE 9

| | Initial pressure | Final pressure | Duration |
|---|---|---|---|
| | (bar) | (bar) | (minutes) |
| Step 1 (pressurization) | 0 | 130 | 0.2 |
| Step 2 (saturation) | 130 | 130 | 90 |
| Step 3 (pressurization) | 130 | 100 | 5 |
| Step 4 (saturation) | 100 | 100 | 2 |
| Step 5 (release/expansion) | 100 | 0 | 0.0018 |

As shown in Table 9, before release step 5, the time-varying pressure profile comprised four steps:
In step 1, the blowing gas pressure was brought from atmospheric pressure to 130 bar with a linear ramp in a time of 0.2 minutes (12 seconds);
In step 2, the blowing gas pressure was maintained at 130 bar for 90 minutes;
In step 3, the blowing gas pressure was decreased from 130 to 100 bar in 5 minutes;
In step 4, the blowing gas pressure was maintained at 100 bar for 2 minutes.

At the end of step 4 the pressure was released at a maximum speed of 1000 bar/s for foaming.

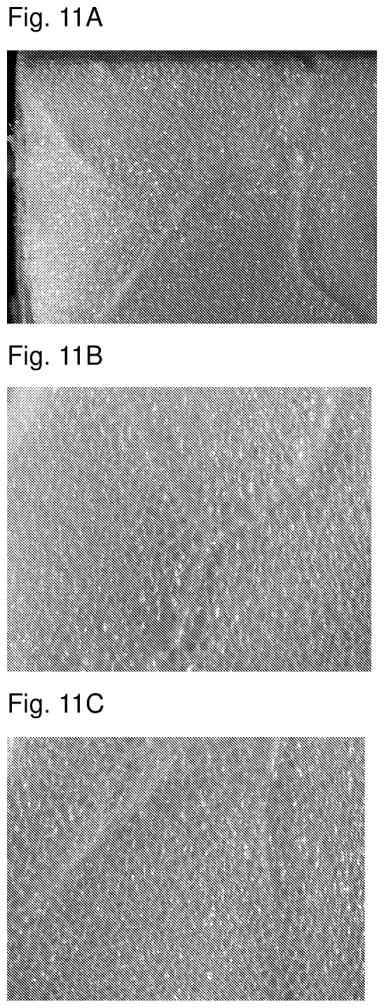

FIG. 11A shows a photo of the resulting sintered foam, with two details of the welding area shown in FIGS. 11B and 11C. Compared to the case of example 8, it shows a gradient morphology at the interface with a coarser morphology and higher density going from the center of the beads towards the edge.

### EXAMPLE 10

### Mechanical Properties

The expanded cylindrical samples resulting from experiments 6, 7, 8 and 9 were subjected to static mono-axial compression tests as described in example 5.

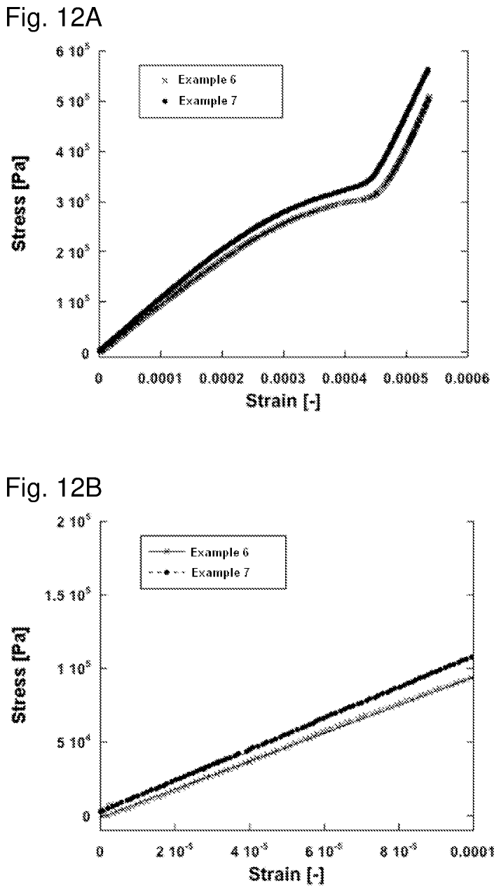

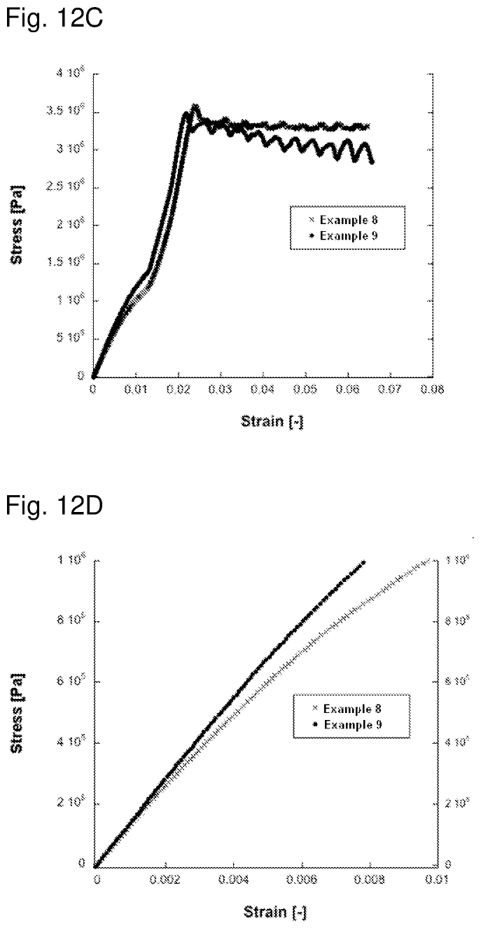

FIGS. 12A and 12B represent the curves obtained from the data acquired from compression tests on the sintered samples of examples 6 and 7, with an average density of 230 g/cm³. In particular, FIG. 12B shows the area used for the calculation of the elastic modulus in compression. FIGS. 12C and 12D represent the curves obtained from the data acquired from the compression tests on the sintered samples of examples 8 and 9, with an average density equal to 110 g/cm³. In particular, FIG. 12D shows the area used for the calculation of the elastic modulus in compression. The following Table 10 shows the elastic modulus values for the different described examples.

TABLE 10

| Sample | modulus of elasticity (GPa) |
|---|---|
| example 6 | 0.95 |
| example 7 | 1.06 |
| example 8 | 0.126 |
| example 9 | 0.143 |

The cylindrical samples in example 7, resulting from gradient beads, with a denser outer layer, were more rigid, for the same average density of 230 g/cm³, than the sample in example 6 by about 12%. The cylindrical samples in example 9, resulting from gradient beads, with a denser outer layer, were more rigid, for the same average density of 110 g/cm³, than the sample in example 8 by about 13%.

### EXAMPLE 11

### Comparison

In this example, the polymer used is Polypropylene (PP), RD734M0, supplied by Borealis with a density of 0.95 g/cm³. Some granules, with a total fixed weight of 2 g, are housed inside a cylindrical steel mold with a diameter of 25 mm and thickness of 9 mm (FIG. 1C), then closed with a flat steel plate and inserted inside the reactor of the batch expansion plant illustrated in FIG. 1 and described above, at room temperature. The reactor was then closed and brought to a temperature of 140° C.

The system was then subjected to the blowing gas (CO₂) solubilization step using the pressure profile described in Table 11.

TABLE 11

| | Initial pressure | Final pressure | Duration |
|---|---|---|---|
| | (bar) | (bar) | (minutes) |
| Step 1 (pressurization) | 0 | 150 | 2 |
| Step 2 (saturation) | 150 | 150 | 90 |
| Step 3 (release/expansion) | 150 | 0 | 0.0018 |

Before the pressure step 3, the temperature of the reactor was brought to 125° C. in 15 min. As shown in Table 11, before release step 3, the pressure profile comprised two steps:
In step 1, the blowing gas pressure was brought from atmospheric pressure to 150 bar with a linear ramp in a time of 0.2 minutes (12 seconds);
In step 2, the blowing gas pressure was maintained at 150 bar for 90 minutes.

At the end of step 2 the pressure was released at a maximum speed of 1000 bar/s for foaming.

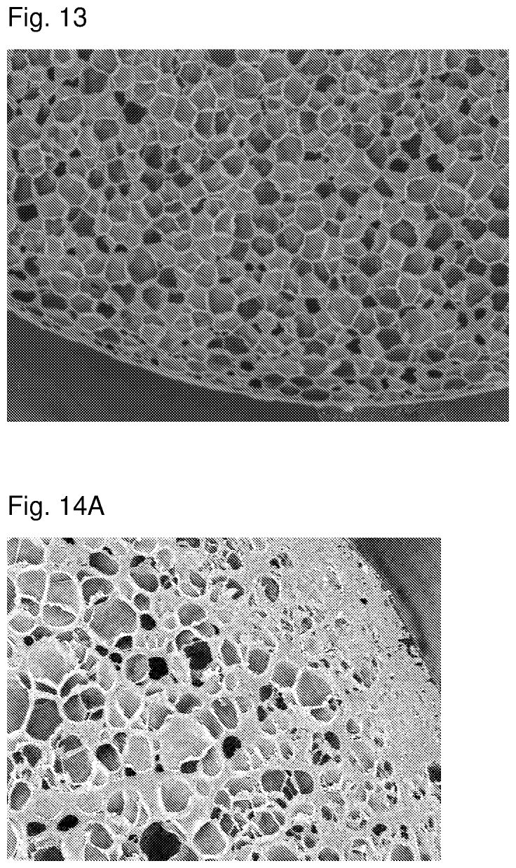

In FIG. 13, a single expanded granule is shown, made according to the procedure described in Table 11 and in which the uniform morphology can be appreciated.

### EXAMPLE 12

### Invention

A sample of PP similar in geometry and positioning in the mold to that described in Example 11 was housed at room temperature in the reactor of the batch expansion system shown in FIG. 1 and described above. The reactor was then closed and brought to a temperature of 140° C. The system was then subjected to the solubilization step using two blowing gases (the first is CO₂; the second is He) using the pressure profile described in Table 12.

TABLE 12

| | Initial pressure | | Final pressure | | Duration |
|---|---|---|---|---|---|
| | (bar) | | (bar) | | (minutes) |
| Step 1 (pressurization) | 0 | | 150 | (CO₂) | 0.2 |
| Step 2 (saturation) | 150 | | 150 | (CO₂) | 90 |
| Step 3 (gas exchange | 150 | (CO₂) | 150 | (He) | 0.5 |
| and partial | | | | | |
| solubilization) | | | | | |
| Step 4 (saturation) | 150 | (He) | 150 | (He) | 4.5 |

| | | | | |
|---|---|---|---|---|
| Step 5 (release/ | 150 | (He) | 0 | 0.0018 |
| expansion) | | | | |

Before the pressure step 3, the temperature of the reactor was brought to 125° C. in 15 min. As shown in Table 12, before release step 5, the pressure profile comprised four steps:
In step 1, the CO₂ gas pressure was brought from atmospheric pressure to 150 bar with a linear ramp in a time of 0.2 minutes (12 seconds);
In step 2, the blowing gas pressure was maintained at 150 bar for 90 minutes;
in step 3, the pressure of the first blowing gas (CO₂) was decreased from 150 to 0 bar in a time of 0.5 minute; at the same time, in the same step, the pressure was balanced, always keeping the total pressure equal to 150 bar, using the second blowing gas He;
In step 4, the blowing gas pressure was maintained at 150 bar for 4.5 minutes.

At the end of step 4 the pressure was released at a maximum speed of 1000 bar/s for foaming.

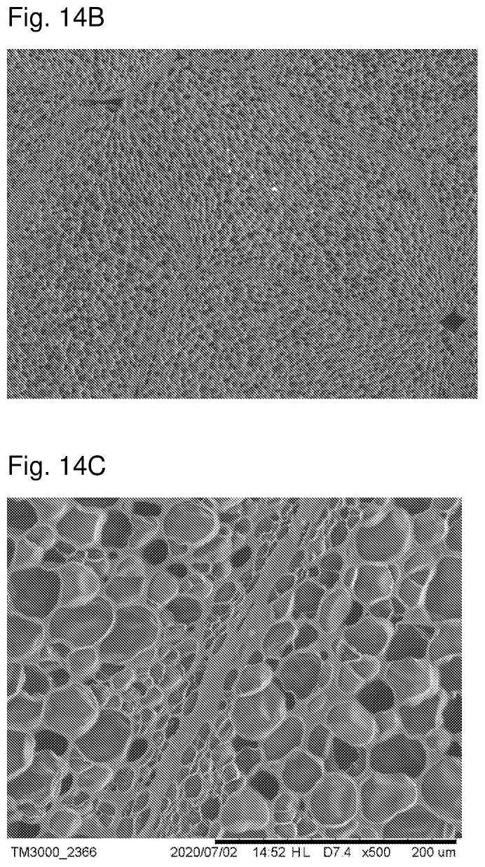

FIG. 14A shows a photo of the resulting foamed beads, with two details of the welding zone shown in FIGS. 14B and 14C. Compared to the case of example 11, it shows a gradient morphology at the interface with higher density on the skin.

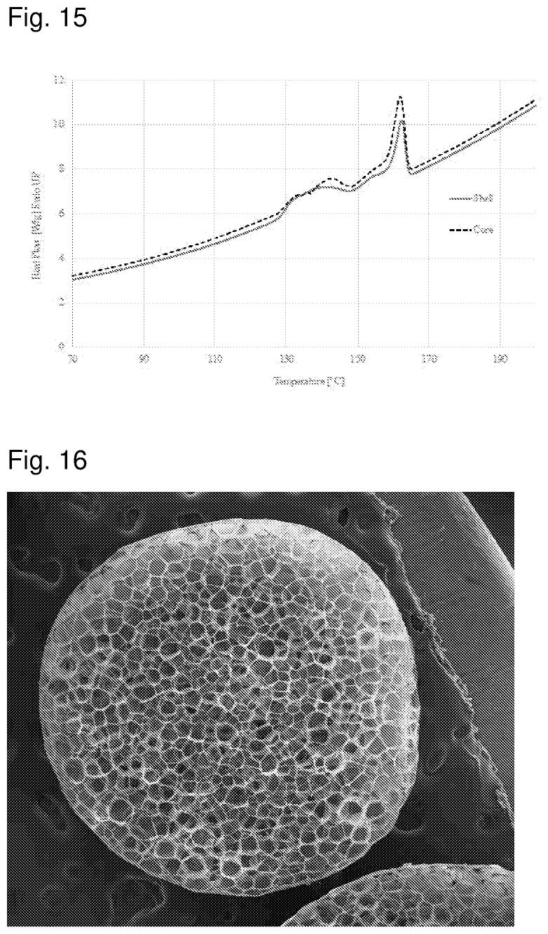

FIG. 15 shows the plots of a DSC test conducted at 10° C./min with N₂ purge on the resulting beads foamed according to the procedure described in Table 12. In particular, several 100 microns slices were cut from the external part of the foamed bead and collectively included (as “Shell”) in a DSC pan for the analysis. Furthermore, the core of the beads was also cut from central region of the remaining bead and included (as “Core”) in a DSC pan for the analysis. As reported in FIG. 15, the DSC plots of the two samples, namely “Shell” and “Core”, taken from the same foamed bead, appeared different, both in terms of the overall degree of crystallinity and in the shape of the curve, proving that the crystalline structure of the graded foamed samples were different, as a consequence of the different foaming extent and treatment with different blowing agents.

### EXAMPLE 13

### Comparison

In this example the polymer used is Poly(lactic acid) (PLA), L175, supplied by Total Corbion. Some granules, with a total fixed weight of 2 g, are housed inside the reactor of the batch expansion plant illustrated in FIG. 1 and described above, at room temperature. The reactor was then closed and kept at a room temperature of 20° C.

The system was then subjected to the blowing gas (CO₂) solubilization step using the pressure profile described in Table 13.

TABLE 13

| | Initial pressure | Final pressure | Duration |
|---|---|---|---|
| | (bar) | (bar) | (minutes) |
| Step 1 (pressurization) | 0 | 20 | 0.2 |
| Step 2 (saturation) | 20 | 20 | 900 |
| Step 3 (release) | 20 | 0 | 2 |

As shown in Table 13, before release step 3, the pressure profile comprised two steps:
In step 1, the blowing gas pressure was brought from atmospheric pressure to 20 bar with a linear ramp in a time of 0.2 minutes (12 seconds);
In step 2, the blowing gas pressure was maintained at 20 bar for 900 minutes;

At the end of step 2 the pressure was released at a maximum speed of 10 bar/min. In these low temperature conditions, the CO₂-laden granules do not foam. For foaming, the granules were heated by a temperature gun at 110° C. for 5 seconds and then cooled in air.

In FIG. 16, a single expanded granule is shown, made according to the procedure described in Table 13 and in which the uniform morphology can be appreciated.

### EXAMPLE 14

### Invention

A sample of PLA similar in geometry to that described in Example 13 was housed at room temperature in the reactor of the batch expansion system shown in FIG. 1 and described above. The reactor was then closed and kept at a room temperature of 20° C. The system was then subjected to the blowing gas (CO₂) solubilization step using the pressure profile described in Table 14.

TABLE 14

| | Initial pressure | Final pressure | Duration |
|---|---|---|---|
| | (bar) | (bar) | (minutes) |
| Step 1 (pressurization) | 0 | 20 | 0.2 |
| Step 2 (saturation) | 20 | 20 | 900 |
| Step 3 (pressurization) | 20 | 40 | 0.2 |
| Step 4 (saturation) | 40 | 40 | 60 |
| Step 5 (release) | 40 | 0 | 2 |

As shown in Table 14, before release step 5, the pressure profile comprised four steps:
In step 1, the blowing gas pressure was brought from atmospheric pressure to 20 bar with a linear ramp in a time of 0.2 minutes (12 seconds);
In step 2, the blowing gas pressure was maintained at 20 bar for 900 minutes;
In step 3, the blowing gas pressure was increased from 20 to 40 bar in 0.2 minutes;
In step 4, the blowing gas pressure was maintained at 40 bar for 60 minutes.

At the end of step 4 the pressure was released at a maximum speed of 20 bar/min. At these low temperature conditions, the CO₂-laden granules do not foam. For foaming, the granules were heated by a temperature gun at 110° C. for 5 seconds and then cooled in air.

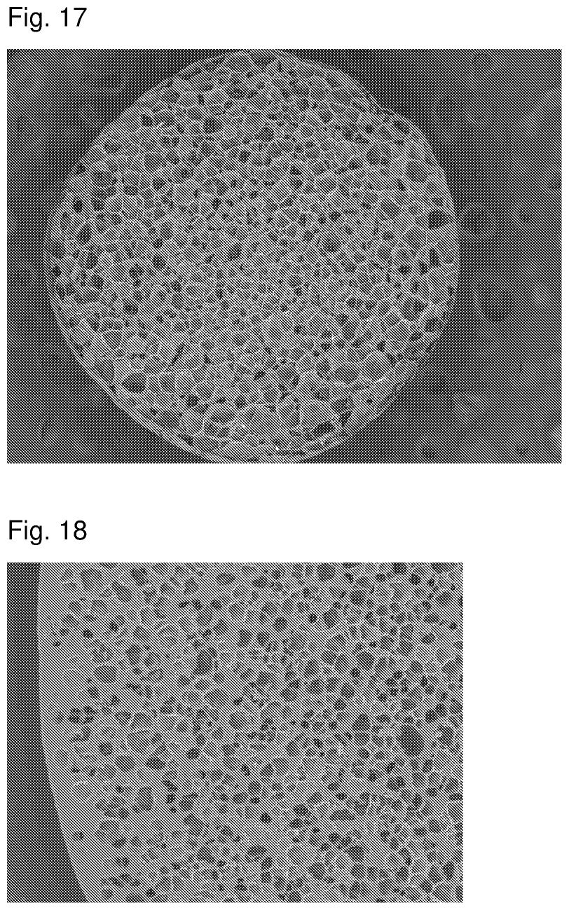

In FIG. 17, a single expanded granule is shown, made according to the procedure described in Table 14 and in which the graded morphology can be appreciated, characterized by larger bubbles in the outer layers.

### EXAMPLE 15

### Invention

A sample of PLA similar in geometry to that described in Example 13 was housed at room temperature in the reactor of the batch expansion system shown in FIG. 1 and described above. The reactor was then closed and kept at a room temperature of 20° C.

The system was then subjected to the blowing gas (CO₂) solubilization step using the pressure profile described in Table 15.

TABLE 15

| | Initial pressure | Final pressure | Duration |
|---|---|---|---|
| | (bar) | (bar) | (minutes) |
| Step 1 (pressurization) | 0 | 20 | 0.2 |
| Step 2 (saturation) | 20 | 20 | 900 |
| Step 3 (pressurization) | 20 | 5 | 1 |
| Step 4 (saturation) | 5 | 5 | 5 |
| Step 5 (release) | 5 | 0 | 0.25 |

As shown in Table 15, before release step 5, the pressure profile comprised four steps:
In step 1, the blowing gas pressure was brought from atmospheric pressure to 20 bar with a linear ramp in a time of 0.2 minutes (12 seconds);
In step 2, the blowing gas pressure was maintained at 20 bar for 900 minutes;
in step 3, the pressure was brought from 20 bar to 5 bar in a time of 1 min; meanwhile the temperature of the pressure vessel was changed to 40° C.;
In step 4, the blowing gas pressure was maintained at 5 bar for 60 minutes;

At the end of step 4 the pressure was released at a maximum speed of 20 bar/min. In these low temperature conditions, the CO₂-laden granules do not foam. When the granules are heated for foaming (by a temperature gun at 110° C. for 5 seconds for foaming and then cooled in air), the resulting foams are characterized by an outer dense layer and an inner foamed layer, as shown in FIG. 18.

### EXAMPLE 16

### Invention

A sample of PLA similar in geometry to that described in Example 13 was housed at room temperature in the reactor of the batch expansion system shown in FIG. 1 and described above. The reactor was then closed and kept at a room temperature of 20° C.

The system was then subjected to the solubilization step using two blowing gases (the first is CO₂; the second is N₂) using the pressure profile described in Table 16.

TABLE 16

| | Initial pressure | | Final pressure | | Duration |
|---|---|---|---|---|---|
| | (bar) | | (bar) | | (minutes) |
| Step 1 (pressurization) | 0 | | 20 | (CO₂) | 0.2 |
| Step 2 (saturation) | 20 | | 20 | (CO₂) | 900 |
| Step 3 (gas exchange | 20 | (CO₂) | 100 | (N₂) | 1 |
| and partial | | | | | |
| solubilization) | | | | | |
| Step 4 (saturation) | 100 | (N₂) | 100 | (N₂) | 60 |

| | | | |
|---|---|---|---|
| Step 5 (release) | 100 | 0 | 2 |

As shown in Table 16, before release step 5, the pressure profile comprised four steps:
In step 1, the CO₂ gas pressure was brought from atmospheric pressure to 20 bar with a linear ramp in a time of 0.2 minutes (12 seconds);
In step 2, the blowing gas pressure was maintained at 20 bar for 900 minutes;
in step 3, the pressure of the first blowing gas (CO₂) was decreased from 20 to 0 bar in a time of 1 minute; at the same time, in the same step, the pressure was increased using the second blowing gas N₂;
In step 4, the blowing gas pressure was maintained at 100 bar for 60 minutes.

At the end of step 4 the pressure was released at a maximum speed of 50 bar/min. At these low temperature conditions, the CO₂- and N₂-laden granules do not foam. For foaming, the granules were heated by a temperature gun at 110° C. for 5 seconds and then cooled in air.

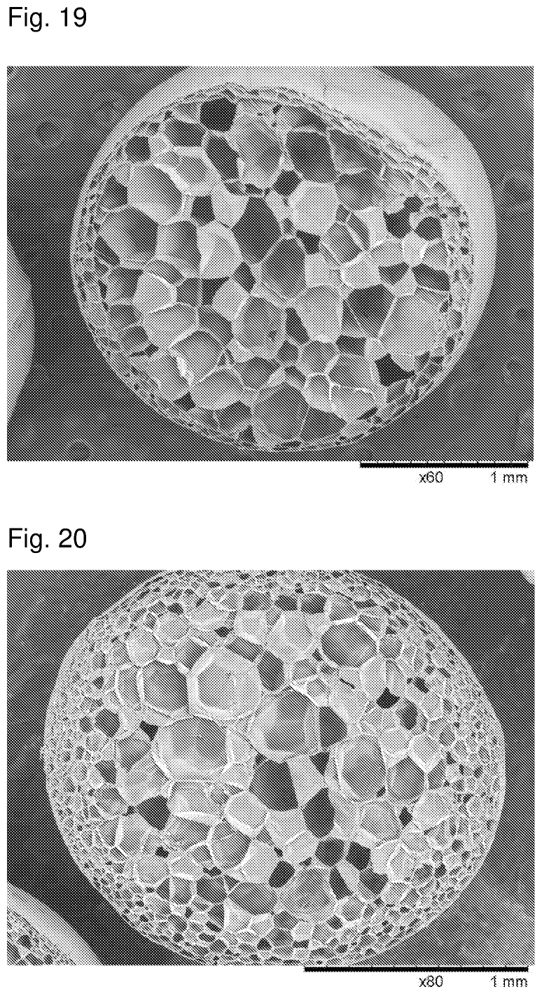

In FIG. 19, a single expanded granule is shown, made according to the procedure described in Table 16 and in which the graded morphology can be appreciated. In particular, the outer layer, N₂-laden, show a finer morphology, characteristic of the N₂-foamed polymers, while in the inner layer, a coarser morphology is evident, characteristic of the CO₂-foamed polymers.

### EXAMPLE 17

### Invention

A sample of PLA similar in geometry to that described in Example 13 was housed at room temperature in the reactor of the batch expansion system shown in FIG. 1 and described above. The reactor was then closed and kept at a room temperature of 20° C.

The system was then subjected to the solubilization step using two blowing gases (the first is CO₂; the second is N₂) using the pressure profile described in Table 17.

TABLE 17

| | Initial pressure | | Final pressure | | Duration |
|---|---|---|---|---|---|
| | (bar) | | (bar) | | (minutes) |
| Step 1 (pressurization) | 0 | | 20 | (CO₂) | 0.2 |
| Step 2 (saturation) | 20 | | 20 | (CO₂) | 900 |
| Step 3 (gas exchange | 20 | (CO₂) | 100 | (N₂) | 1 |
| and partial | | | | | |
| solubilization) | | | | | |
| Step 4 (saturation) | 100 | (N₂) | 100 | (N₂) | 120 |

| | | | |
|---|---|---|---|
| Step 5 (release) | 100 | 0 | 2 |

As shown in Table 17, before release step 5, the pressure profile comprised four steps:
In step 1, the CO₂ gas pressure was brought from atmospheric pressure to 20 bar with a linear ramp in a time of 0.2 minutes (12 seconds);
In step 2, the blowing gas pressure was maintained at 20 bar for 900 minutes;
in step 3, the pressure of the first blowing gas (CO₂) was decreased from 20 to 0 bar in a time of 1 minute; at the same time, in the same step, the pressure was increased using the second blowing gas N₂;
In step 4, the blowing gas pressure was maintained at 100 bar for 120 minutes.

At the end of step 4 the pressure was released at a maximum speed of 50 bar/min. At these low temperature conditions, the CO₂- and N₂-I granules do not foam. For foaming, the granules were heated by a temperature gun at 110° C. for 5 seconds and then cooled in air.

In FIG. 20, a single expanded granule is shown, made according to the procedure described in Table 17 and in which the graded morphology can be appreciated. In particular, the outer layer, N₂-laden, show a finer morphology, characteristic of the N₂-foamed polymers, while in the inner layer, a coarser morphology is evident, characteristic of the CO₂-foamed polymers.

### EXAMPLE 18

### Invention

A sample of PLA similar in geometry to that described in Example 13 was housed at room temperature in the reactor of the batch expansion system shown in FIG. 1 and described above. The reactor was then closed and kept at a room temperature of 20° C.

The system was then subjected to the blowing gas (CO₂) solubilization step using the pressure profile described in Table 18.

TABLE 18

| | Initial pressure | Final pressure | Duration |
|---|---|---|---|
| | (bar) | (bar) | (minutes) |
| Step 1 (pressurization) | 0 | 20 | 0.2 |
| Step 2 (saturation) | 20 | 20 | 900 |
| Step 3 (pressurization) | 20 | 5 | 1 |
| Step 4 (saturation) | 5 | 5 | 60 |
| Step 5 (release) | 5 | 0 | 0.25 |

As shown in Table 18, before release step 5, the pressure profile comprised four steps:
In step 1, the CO₂ gas pressure was brought from atmospheric pressure to 20 bar with a linear ramp in a time of 0.2 minutes (12 seconds);
In step 2, the blowing gas pressure was maintained at 20 bar for 900 minutes;
in step 3, the pressure was brought from 20 bar to 5 bar in a time of 1 min;
In step 4, the blowing gas pressure was maintained at 5 bar for 60 minutes;

At the end of step 4 the pressure was released at a maximum speed of 20 bar/min. At these low temperature conditions, the CO₂-laden granules do not foam. For foaming, the granules were heated by a temperature gun at 110° C. for 5 seconds and then cooled in air.

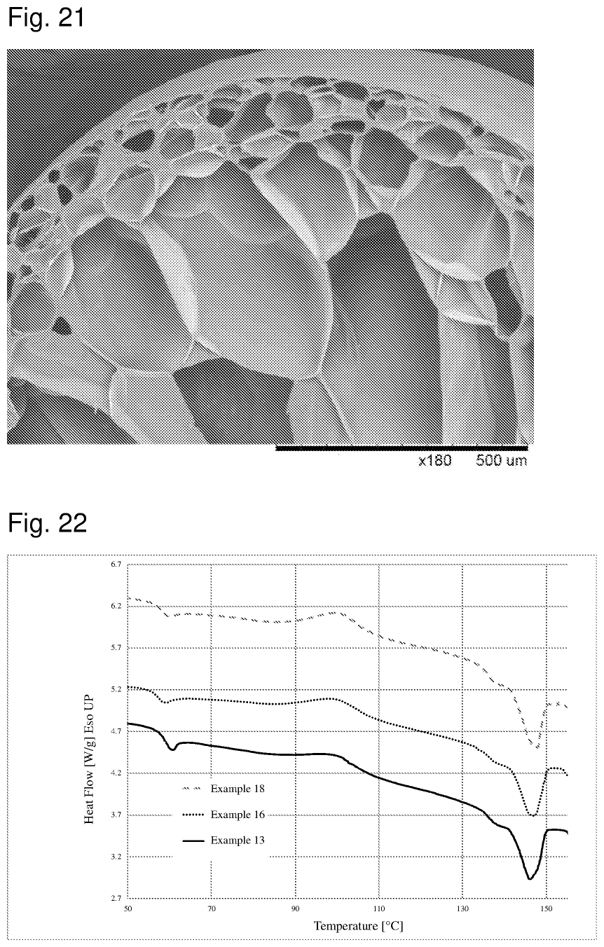

In FIG. 21, a single expanded granule is shown, made according to the procedure described in Table 18 and in which the graded morphology can be appreciated. In particular, the outer layer, where the CO₂ diffused out from the solution, show a high-density layer with respect to the inner layer, due to the decreased amount of blowing agent.

FIG. 22 shows the plots of a DSC test conducted at 10° C./min with N₂ purge on the resulting beads foamed according to the procedure described in Examples 13, 16 and 18. The resulting DSC data are also collected in Table 19.

In particular, differently from the case of FIG. 15, the whole samples were tested, without slicing the core and shell. By evaluating the peak areas, the degree of crystallinity of the different foamed beads can be evaluated. It can be observed that, due to the different treatment, the degree of crystallinity can drop by 21% when adopting procedure described in Example 16 (graded foam) with respect to Example 13 (uniform foam) and by 61% when adopting procedure 18.

TABLE 19

| | | | Degree of |
|---|---|---|---|
| | Cold Crystallization | Melting | crystallinity |
| | Enthalpy (J/g) | Enthalpy (J/g) | of the bead (%) |
| Example 13 | 10.60 | 24.36 | 14.7 |
| Example 16 | 12.73 | 23.63 | 11.6 |
| Example 18 | 15.23 | 20.75 | 5.7 |

1-35. (canceled)

36. A process to prepare a foamed polymeric material comprising sintered expanded beads by the use of one or more blowing agents, characterized in that this process comprises the following steps:
providing an expandable polymeric material in the form of granules,
solubilizing with a time-varying pressure profile said one or more blowing agents in the expandable polymeric material,
expanding said granules to form said expanded beads by instantly releasing the pressure or by pressure release and subsequent heating, and
sintering together said expanded beads, preferably at a temperature higher than 30° C.

37. The process according to claim 36, characterized in that said expandable polymeric material is selected from the group consisting of thermoplastic and thermosetting polymeric materials.

38. The process according to claim 37, characterized in that said thermoplastic polymeric material is selected from the group comprising polyolefins, polyurethanes, polyesters and polyamides.

39. The process according to claim 37, characterized in that said thermosetting polymeric material is selected from the group comprising polyurethanes, epoxy resins, melamine resins, polyphenols, and polyimides.

40. The process according to claim 36, characterized in that said granules have a maximum diameter between 0.1 mm and 10 mm, preferably between 0.5 mm and 5 mm.

41. The process according to claim 36, characterized in that said time-varying pressure profile varies over time in a periodic or non-periodic manner.

42. The process according to claim 36, characterized in that said time-varying pressure profile varies from a minimum pressure equal to atmospheric pressure to a maximum of 300 bar, preferably from atmospheric pressure to 250 bar, and advantageously from atmospheric pressure to 200 bar.

43. The process according to claim 36, characterized by the use of a blowing agent.

44. The process according to claim 36, characterized by the use of a mixture of two or more blowing agents.

45. The process according to claim 44, characterized in that the concentration of said blowing agents in said mixture varies over time.

46. The process according to claim 36, characterized in that one or more blowing agents are selected from the group consisting of inert gases, carbon dioxide, and aliphatic hydrocarbons (linear, branched or cyclic) substituted or unsubstituted having from 3 to 8 carbon atoms.

47. The process according to claim 46, characterized in that said one or more blowing agents are selected from the group comprising nitrogen, carbon dioxide, n-butane, n-pentane, iso-butane, n-pentane, 1,1,1,2-tetrafluoroethane (Freon R-134a), 1,1-difluoroethane (Freon R-152a), difluoromethane (Freon R-32), pentafluoroethane (Freon R-125), sulphur hexafluoride.

48. A foamed polymeric material comprising sintered expanded beads obtained by the process as defined in claim 36, where said foamed polymeric material, for the same average density, shows mechanical properties dependent on said time-varying pressure profile.

49. A foamed polymeric material comprising sintered expanded beads characterized by welding layers between said sintered expanded beads with a density greater or lower than the average density of said foamed polymeric material.

50. The foamed polymeric material according to claim 49, characterized in that said sintered expanded beads comprise a welding layer and an inner portion of said welding layer comprising at least one expanded layer, where the density of said welding layer is greater than the density of said inner portion.

51. The foamed polymeric material according to claim 49, characterized in that said sintered expanded beads comprise a welding layer and an inner portion of said welding layer comprising at least one expanded layer, where the density of said welding layer is lower than the density of said inner portion.

52. The foamed polymeric material according to claim 49, characterized in that said sintered expanded beads comprise an inner portion of said welding layer comprising at least two layers with varying density and/or morphology and with gradual variation of density and/or morphology.

53. The foamed polymeric material according to claim 52, characterized in that said sintered expanded beads comprise an inner portion of said welding layer comprising at least one layer with lower density and finer morphology and at least one layer with higher density and coarser morphology.

54. The foamed polymeric material according to claim 52, characterized in that said expanded beads sintered together comprise an inner portion of said welding layer comprising at least one layer with lower density and coarser morphology and at least one layer with higher density and finer morphology.

55. The foamed polymeric material according to claim 52, characterized in that said expanded beads sintered together comprise an inner portion of said welding layer comprising at least one layer with lower density and at least one layer with higher density, with uniform morphology.

56. The foamed polymeric material according to claim 52, characterized in that said expanded beads sintered together comprise an inner portion of said welding layer comprising at least one layer with coarser morphology and at least one layer with finer morphology, with uniform density.

57. The foamed polymeric material according to claim 52, characterized in that the interface between said at least two layers with different density and/or morphology does not show discontinuity of morphology and/or density.

58. The foamed polymeric material according to claim 49, characterized by welding layers between said sintered expanded beads with a degree of crystallinity higher or lower than the average degree of crystallinity of said foamed polymeric material.

59. The foamed polymeric material according to claim 52, characterized in that said sintered expanded beads comprise an inner portion comprising at least two layers with different degree of crystallinity.

60. A manufactured article made in whole or in part from a foamed polymeric material according to claim 49.

61. The manufactured article according to claim 60, where said manufactured article is selected from the group consisting of protection systems (shin guards, back guards, shoulder and elbows guards, knee pads, shells and pads, bulletproof vests), helmets (bicycle, motorbike, work and combat), orthopedic prostheses, dental prostheses, epidermis prostheses, tissue engineering scaffolds, sound absorption and insulation sheets and systems, thermal insulation sheets and systems, soles and elements for sports footwear, car panels, sports equipment, furniture, packaging, membranes and filtration systems, sacrificial foams for ceramic materials and porous metals, foams for diffusers and aerators, biomedical systems, pads and patches for controlled drug delivery, progressive mechanical response systems, progressive functional response systems, electromagnetic shielding systems, catalytic systems, aerospace and aeronautic foams, foams for optoelectronics, flotation systems, frames and chassis, and spectacle frames.
